(19) United States
(12) Patent Application Publication
(10) Pub. No.: US 2013/0291639 A1
(43) Pub. Date: Nov. 7, 2013

(54) VIBRATING PIECE AND MANUFACTURING METHOD FOR THE VIBRATING PIECE, GYRO SENSOR, AND ELECTRONIC APPARATUS AND MOBILE BODY

(71) Applicant: SEIKO EPSON CORPORATION, Tokyo (JP)

(72) Inventor: Ryuta NISHIZAWA, Matsumoto (JP)

(73) Assignee: Seiko Epson Corporation, Tokyo (JP)

(21) Appl. No.: 13/874,807

(22) Filed: May 1, 2013

(30) Foreign Application Priority Data
May 7, 2012 (JP) 2012-106068

(51) Int. Cl. G01C 19/56; G01C 25/00

(52) U.S. Cl. CPC G01C 19/56; G01C 25/00
USPC 73/504.12; 29/25.35

(57) ABSTRACT

A vibrating piece includes a driving arm at least partially formed by a piezoelectric body, the driving arm including a first surface spreading along the direction of excited vibration, a second surface on the opposite side of the first surface, a first side surface configured to connect the first surface and the second surface, and a second side surface arranged on the opposite side of the first side surface and configured to connect the first surface and the second surface. The vibrating piece includes first electrodes arranged at least on one surface side of the first surface and the second surface and second electrodes arranged on at least one surface side of the first side surface and the second side surface. The first electrodes are provided asymmetrically with respect to an equally dividing plane of the driving arm orthogonal to the direction of the excited vibration of the driving arm.

### BACKGROUND

1. Technical Field

The present invention relates to a vibrating piece and a manufacturing method for the vibrating piece, a gyro sensor in which the vibrating piece is used, an electronic apparatus and a mobile body incorporating the vibrating piece, and the like.

2. Related Art

For example, a vibrating piece used in a gyro sensor is generally known. In detection of an angular velocity, driving arms of the vibrating piece vibrate, for example, in parallel to an xy plane (called “in-plane vibration”). When the angular velocity is applied to the vibrating piece around a y axis, a vibrating direction of the driving arms is changed by the action of the Coriolis force. A force component is generated anew in parallel to a yz plane according to the Coriolis force. The force component causes the motion of detection arms in parallel to the yz plane (called “out-of-plane vibration”). Consequently, an output signal corresponding to the force component is output from the detection arms.

JP-A-2008-267983 (Patent Literature 1), JP-A-2008-14887 (Patent Literature 2), and JP-A-7-280572 (Patent Literature 3) are examples of related art.

When the shape of the driving arms deviates from, for example, a shape designed on the basis of a machining error, oblique vibration is caused by the driving arms even in a state in which an angular velocity motion is not applied to the vibrating piece, i.e., so-called vibration leakage occurs. In the output signal of the detection arms, a component of the vibration leakage is superimposed on the force component. As a result, an S/N ratio of the output signal is deteriorated. An angular velocity signal is output from the vibrating piece in a state in which the angular velocity motion is not input to the vibrating piece. In Patent Literatures 1 to 3, detection electrodes are partially removed in removal of the component of leaked vibration. However, such removal of the detection electrodes induces deterioration in signal intensity. Therefore, the S/N ratio of the output signal cannot be improved as expected.

### SUMMARY

An advantage of some aspects of the invention is to provide a vibrating piece that can improve the S/N ratio of the output signal.

(1) An aspect of the invention relates to a vibrating piece including: a base section, a driving arm and a detection arm formed by piezoelectric bodies and extending from the base section; and electrodes fixed to the driving arm and including notch portions in a part thereof.

The vibrating piece may include a driving arm at least partially formed by a piezoelectric body. The driving arm may include a first surface spreading along the direction of excited vibration, a second surface on the opposite side of the first surface, a first side surface configured to connect the first surface and the second surface, and a second side surface arranged on the opposite side of the first side surface and configured to connect the first surface and the second surface. The vibrating piece may include: first electrodes arranged at least on one surface side of the first surface and the second surface; and second electrodes arranged on at least one surface side of the first side surface and the second side surface. The first electrodes may be provided asymmetrically with respect to an equally dividing plane of the driving arm orthogonal to the direction of the excited vibration of the driving arm.

The vibrating piece can be used in detection of an angular velocity. In the detection of the angular velocity, vibration is excited by the driving arm. At this point, when an angular velocity motion is applied to the driving arm, a vibrating direction of the driving arm is changed by the action of the Coriolis force. A force component is generated anew in a specific direction according to the Coriolis force. The force component causes a motion of the detection arm. Consequently, an output signal corresponding to the force component is output from the detection arm.

In the vibrating piece, the notch portions are formed in the electrodes according to a machining error of the driving arm. The spread of the electrodes is adjusted. A range of a voltage acting on the piezoelectric body from the electrodes is adjusted. Consequently, the vibrating direction of the driving arm is adjusted. Even if the shape of the driving arm deviates from a designed shape, the vibration leakage is suppressed (or eliminated). In the output signal of the detection arm, the influence of the vibration leakage can be minimized (or avoided). As a result, the S/N ratio of the output signal is improved.

(2) The electrodes may be formed asymmetrically with respect to the equally dividing plane of the driving arm orthogonal to the direction of the excited vibration of the driving arm. When the notch portions are formed on the basis of the equally dividing plane in this way, the oblique vibration can be easily suppressed (or eliminated).

(3) The driving arm may be formed as a square pole including a first surface spreading along the direction of excited vibration, a second surface on the opposite side of the first surface, a first side surface and a second side surface configured to connect the first surface and the second surface. The electrodes may include first electrodes fixed to the first surface and the second surface and second electrodes fixed to the first side surface and the second side surface. The notch portions may be formed in the first electrodes at least on the first surface to expand a distance between the first electrodes and the second side surface compared with a distance between the first electrodes and the first side surface.

The first electrodes may be arranged on the first surface side, the second electrodes maybe arranged on the first side surface side and the second side surface side, and a distance between the first electrodes arranged on the first surface side and the second electrodes arranged on the first side surface side may be shorter than a distance between the first electrodes arranged on the first surface side and the second electrodes arranged on the second side surface side.

The first surface and the second surface of the driving arm can be equivalent to plate surfaces. Therefore, the electrodes can be easily machined from a direction orthogonal to the first surface. The notch portions can be easily formed. For example, a shadow can be prevented from being formed in the application of the lithography technique. Labor and time for machining can be minimized.

(4) The notch portions may be formed in the first electrodes on the second surface to expand a distance between the first electrodes and the first side surface compared with a distance between the first electrodes and the second side surface. As explained above, the first surface and the second surface of the driving arm can be equivalent to plate surfaces. Similarly, the notch portions can be easily formed. Labor and time for machining can be minimized.

The first electrodes may be arranged on the second surface side, and a distance between the first electrodes arranged on the second surface side and the second electrodes arranged on the second side surface side may be shorter than a distance between the first electrodes arranged on the second surface side and the second electrodes arranged on the first side surface side.

(5) The driving arm may include a first surface spreading along a direction of excited vibration, a second surface on the opposite side of the first surface, a first side surface and a second side surface configured to connect the first surface and the second surface, a groove formed on the first surface and extending in the longitudinal direction of the driving arm, the groove being a first groove including a first wall surface on the first side surface side and a second wall surface on the second side surface side, and a groove formed on the second surface and extending in the longitudinal direction of the driving arm, the groove being a second groove including a third wall surface on the first side surface side and a fourth wall surface on the second side surface side. The electrodes may include first electrodes fixed to the first wall surface, the second wall surface, the third wall surface, and the fourth wall surface and second electrodes fixed to the first side surface and the second side surface and may be formed asymmetrically with respect to equally dividing planes respectively orthogonal to the first side surface and the second side surface on bisectors of the first side surface and the second side surface at an equal distance from the first surface and the second surface. The piezoelectric bodies are held between the first electrodes and the second electrodes. Therefore, excitation efficiency is improved. An effect of the notch portions is improved. The oblique vibration may be suppressed (or eliminated) by as little machining as possible.

The vibrating piece may include a driving arm at least partially formed by a piezoelectric body. The driving arm may include a first surface spreading along the direction of excited vibration, a second surface on the opposite side of the first surface, a first side surface configured to connect the first surface and the second surface, a second side surface arranged on the opposite side of the first side surface and configured to connect the first surface and the second surface, a groove provided on the first surface and extending in the longitudinal direction of the driving arm, the groove being a first groove including a first wall surface on the first side surface side and a second wall surface on the second side surface side, and a groove provided on the second surface and extending in the longitudinal direction of the driving arm, the groove being a second groove including a third wall surface on the first side surface side and a fourth wall surface on the second side surface side. The vibrating piece may include: first electrodes arranged on the first wall surface side, the second wall surface side, the third wall surface side, and the fourth wall surface side; and second electrodes arranged on the first side surface side and the second side surface side. The second electrodes may be arranged, on at least one of the first side surface side and the second side surface side, asymmetrically with respect to equally dividing planes respectively orthogonal to the first side surface and the second side surface on bisectors of the first side surface and the second side surface at an equal distance from the first surface and the second surface.

(6) Another aspect of the invention relates to a vibrating piece including: abase formed by a non-piezoelectric body; a driving arm and a detection arm formed of non-piezoelectric bodies and extending from the base; a piezoelectric body fixed to the driving arm; and electrodes fixed to the piezoelectric body and including notch portions.

The vibrating piece may include a driving arm formed by a non-piezoelectric body. The vibrating piece may include: a piezoelectric body provided in the driving arm; and electrodes provided in the piezoelectric body. The electrodes may be provided asymmetrically with respect to an equally dividing plane of the driving arm orthogonal to the direction of excited vibration of the driving arm.

The vibrating piece can be used in detection of an angular velocity. In the detection of the angular velocity, vibration is excited by the driving arm. At this point, when an angular velocity motion is applied to the driving arm, a vibrating direction of the driving arm is changed by the action of the Coriolis force. A force component is generated anew in a specific direction according to the Coriolis force. The force component causes a motion of the detection arm. Consequently, an output signal corresponding to the force component is output from the detection arm. In the formation of the vibrating piece, a so-called MEMS (Micro Electro Mechanical Systems) technique can be used.

In the vibrating piece, the notch portions are formed in the electrodes according to a machining error of the driving arm. The spread of the electrodes is adjusted. A range of a voltage acting on the piezoelectric body from the electrodes is adjusted. Consequently, the vibrating direction of the driving arm is adjusted. Even if the shape of the driving arm deviates from a designed shape, oblique vibration is suppressed (or eliminated). In the output signal of the detection arm, the influence of vibration leakage can be minimized (or avoided). As a result, an S/N ratio of the output signal is improved.

(7) The electrodes may be formed asymmetrically with respect to the equally dividing plane of the driving arm orthogonal to the direction of the excited vibration of the driving arm. When the notch portions are formed on the basis of the equally dividing plane in this way, the oblique vibration can be easily suppressed (or eliminated).

(8) The vibrating piece may be used by being incorporated in a gyro sensor. The gyro sensor may include the vibrating piece.

(9) The vibrating piece may be used by being incorporated in an electronic apparatus. The electronic apparatus may include the vibrating piece.

(10) The vibrating piece may be used by being incorporated in a mobile body. The mobile body may include the vibrating piece.

(11) Still another aspect of the invention relates to a manufacturing method for a vibrating piece including: arranging a vibrating piece including a base, a driving arm and a detection arm at least partially formed by piezoelectric bodies and extending from the base, and electrodes fixed to the driving arm; and partially deleting the electrodes and forming notch portions in the electrodes. According to the manufacturing method, the vibrating piece can be manufactured. Tuning of excited vibration can be realized.

The manufacturing method may include: arranging a vibrating piece including a driving arm at least partially formed by a piezoelectric body and electrodes provided in the driving arm; and partially deleting the electrodes and forming notch portions in the electrodes.

(12) Yet another aspect of the invention relates to a manufacturing method for a vibrating piece including: arranging a vibrating piece including a base formed by a non-piezoelectric body, a driving arm and a detection arm formed by non-piezoelectric bodies and extending from the base, a piezoelectric body fixed to the driving arm, and electrodes fixed to the piezoelectric body; and partially deleting the electrodes and forming notch portions in the electrodes. According to the manufacturing method, the vibrating piece can be manufactured. Tuning of excited vibration can be realized.

The manufacturing method may include: arranging a vibrating piece including a driving arm formed by a non-piezoelectric body, a piezoelectric body provided in the driving arm, and electrodes provided in the piezoelectric body; and partially deleting the electrodes and forming notch portions in the electrode.

### BRIEF DESCRIPTION OF THE DRAWINGS

The invention will be described with reference to the accompanying drawings, wherein like numbers reference like elements.

FIG. 1 is a vertical sectional view schematically showing the configuration of a gyro sensor according to a first embodiment.

FIG. 2 is an enlarged perspective view schematically showing the configuration of the rear surface of a vibrating piece.

FIG. 3 is a partially enlarged view of FIG. 2.

FIG. 4 is a partially enlarged view of FIG. 2.

FIG. 5 is an enlarged sectional view taken along line 5-5 shown in FIG. 2.

FIG. 6 is a perspective view of the vibrating piece schematically showing a state of excitation of first and second vibrating arms.

FIG. 7 is a perspective view of the vibrating piece schematically showing a state of vibration of the first and second vibrating arms that vibrate when an angular velocity motion is applied thereto.

FIG. 8 is a vertical sectional view corresponding to FIG. 5 and schematically showing a state of excited vibration of the first and second vibrating arms that vibrate when first side surfaces and second side surfaces are orthogonal to first surfaces and second surfaces.

FIG. 9 is a vertical sectional view corresponding to FIG. 5 and schematically showing a state of vibration leakage of the first and second vibrating arms.

FIG. 10 is an enlarged perspective view corresponding to FIG. 3 and schematically showing the configuration of the rear surface of a vibrating piece manufactured as designed.

FIG. 11 is a vertical sectional view corresponding to FIG. 5 and schematically showing the configuration of first and second vibrating arms used in a gyro sensor according to a second embodiment.

FIG. 12 is a perspective view schematically showing the configuration of a vibrating piece used in a gyro sensor according to a third embodiment.

FIG. 13 is an enlarged sectional view taken along line 13-13 shown in FIG. 12.

FIG. 14 is a perspective view schematically showing the configuration of a vibrating piece used in a gyro sensor according to a fourth embodiment.

FIG. 15 is an enlarged sectional view taken along line 15-15 shown in FIG. 14.

FIG. 16 is a perspective view corresponding to FIG. 14 and schematically showing the configuration of the rear surface of a vibrating piece manufactured as designed.

FIG. 17 is a conceptual diagram schematically showing the configuration of a smart phone, which is a specific example of an electronic apparatus.

FIG. 18 is a conceptual diagram schematically showing the configuration of a digital still camera, which is another specific example of the electronic apparatus.

FIG. 19 is a conceptual diagram schematically showing the configuration of an automobile, which is a specific example of a mobile body.

### DESCRIPTION OF EXEMPLARY EMBODIMENTS

Embodiments of the invention are explained below with reference to the accompanying drawings. The embodiments explained below do not unduly limit the content of the invention described in the appended claims. All the configurations explained in the embodiments are not always essential as solving means of the invention.

### (1) Configuration of a Gyro Sensor According to a First Embodiment

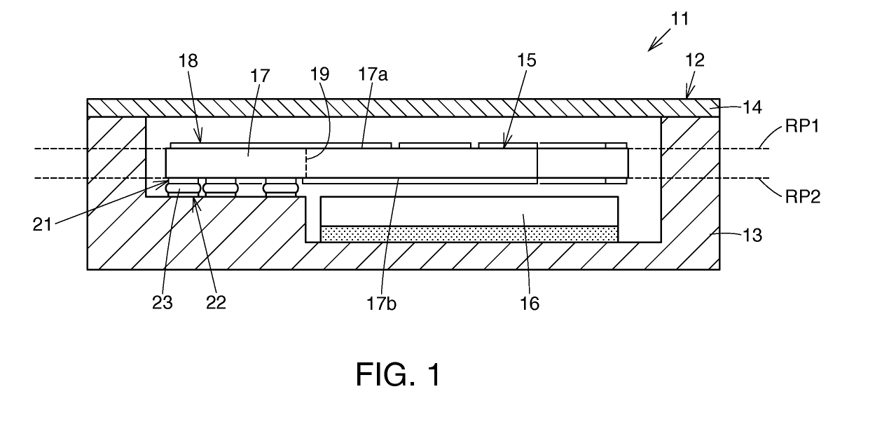

FIG. 1 schematically shows the configuration of a gyro sensor 11 according to a first embodiment. The gyro sensor includes, for example, a box-like container 12. The container 12 includes a container main body 13 and a lid member 14. The opening of the container main body 13 is hermetically closed by the lid member 14. The internal space of the container 12 can be sealed, for example, in a vacuum. The container 12 functions as a rigid body. At least the lid member 14 can be formed of a conductor. If the lid member 14 is grounded, the lid member 14 can exhibit a shield effect against an electromagnetic wave.

A vibrating piece 15 and an IC (integrated circuit) chip 16 are housed in the container 12. The vibrating piece 15 and the IC chip 16 are arranged in the internal space of the container 12. The vibrating piece 15 includes a main body 17 and a conductive film 18. The conductive film 18 is laminated on the surface of the main body 17. The conductive film 18 can be formed of a conductive material such as gold (Au), copper (Cu), and other kinds of metal. The conductive film 18 can be formed by a thin film or a thick film. As it is evident from FIG. 1, the main body 17 of the vibrating piece 15 includes a front surface 17a and a rear surface 17b. The front surface 17a spreads in a first reference plane RP1. The rear surface 17b spreads in a second reference plane RP2. The second reference plane RP2 spreads in parallel to the first reference plane RP1. The entire main body 17 is formed by one piezoelectric body. For example, quartz can be used in the piezoelectric body. The vibrating piece 15 is formed in a so-called tuning fork shape.

The vibrating piece 15 is cantilever-supported by the container main body 13. In the cantilever-support of the vibrating piece 15, a fixing section 19 is partitioned at one end of the main body 17. A connection terminal group 21 is arranged in the fixing section 19. The connection terminal group 21 is formed in a part of the conductive film 18 spreading on the rear surface 17b. The connection terminal group 21 includes a plurality of connection terminals, i.e., conductive material pads. Details of the connection terminals are explained below. On the other hand, a conductive terminal group 22 is arranged on the bottom plate of the container main body 13. The conductive terminal group 22 includes a plurality of connection terminals, i.e., conductive material pads. The connection terminal group 21 of the vibrating piece 15 is joined to the conductive terminal group 22 on the bottom plate. In the joining of the connection terminal group 21, for example, a conductive joining member 23 such as a solder bump or a gold bump can be used. Consequently, the vibrating piece 15 is fixedly attached to the bottom plate of the container main body 13 in the fixing section 19. The conductive terminal group 22 is connected to the IC chip 16 by a wire (not shown in the figure) of the conductive film 18. The IC chip 16 only has to be bonded to, for example, the bottom plate of the container main body 13.

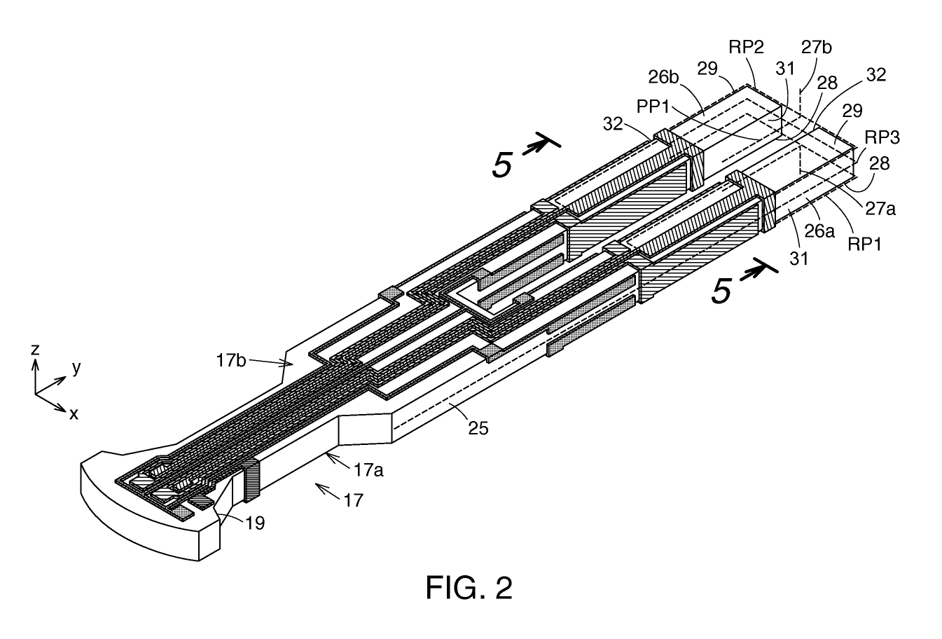

As shown in FIG. 2, the main body 17 of the vibrating piece 15 includes a base 25, a first vibrating arm (a driving arm and a detection arm) 26a and a second vibrating arm (a driving arm and a detection arm) 26b. The first vibrating arm 26a and the second vibrating arm 26b extend in parallel in one direction from the base 25. The first vibrating arm 26a and the second vibrating arm 26b are cantilevered by the base 25. Free end sides (far sides from the base 25) of the first vibrating arm 26a and the second vibrating arm 26b function as the driving arms. Root sides (near sides to the base 25) of the first vibrating arm 26a and the second vibrating arm 26b function as the detection arms. The base 25 has predetermined rigidity.

The first vibrating arm 26a and the second vibrating arm 26b can be formed as square pillars. The first vibrating arm 26a and the second vibrating arm 26b are formed as square poles. The square poles have first surfaces 28 spreading in the first reference plane RP1 and second surfaces 29 spreading in the second reference plane RP2 on the opposite side of the first surfaces 28. The first surfaces 28 and the second surfaces 29 respectively form parts of the front surface 17a and the rear surface 17b. The first surfaces 28 and the second surfaces 29 have a front and back relation each other. The first surfaces 28 and the second surfaces 29 have the identical contour. The first surface 28 of the first vibrating arm 26a and the first surface 28 of the second vibrating arm 26b are formed plane-symmetrically with respect to a plane of symmetry 27a including the center of the front surface 17a of the main body 17 and orthogonal to the first and second reference planes RP1 and RP2. The second surface 29 of the first vibrating arm 26a and the second surface 29 of the second vibrating arm 26b are formed plane-symmetrically with respect to a surface of symmetry 27b including the center of the rear surface 17b of the main body 17 and orthogonal to the first and second reference planes RP1 and RP2.

The square poles include first side surfaces 31 and second side surfaces 32. The first side surfaces 31 connect the first surfaces 28 and the second surfaces 29 each other. The second side surfaces 32 connect the first surfaces 28 and the second surfaces 29 each other on the opposite side of the first side surfaces 31. The first side surfaces 31 and the second side surfaces 32 have a front and back relation.

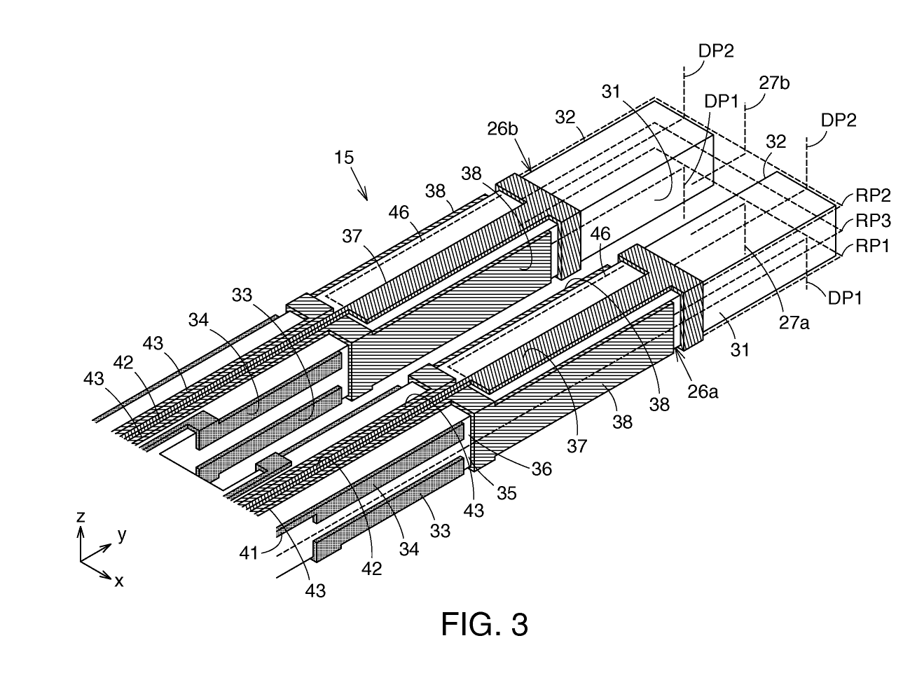

As shown in FIG. 3, the conductive film 18 forms first detection electrodes 33 and second detection electrodes 34. The first detection electrodes 33 and the second detection electrodes 34 are fixed to the first side surfaces 31 and the second side surfaces 32 of the first vibrating arm 26a and the second vibrating arm 26b. In fixing the first detection electrodes 33 and the second detection electrodes 34, the first side surfaces 31 and the second side surfaces 32 of the first vibrating arm 26a and the second vibrating arm 26b are respectively divided into first regions 35 and second regions 36. In dividing the first side surfaces 31 and the second side surfaces 32, a third reference plane RP3 is imaginarily set. The third reference plane RP3 is arranged at an equal distance from the first reference plane RP1 and the second reference plane RP2 while spreading in parallel to the first and second reference planes RP1 and RP2. The first side surfaces 31 and the second side surfaces 32 are respectively bisected into the first regions 35 and the second regions 36 by the third reference plane RP3. The first detection electrodes 33 are arranged in the respective first regions 35. The first detection electrodes 33 respectively hold the first vibrating arm 26a and the second vibrating arm 26b between the first reference plane RP1 and the third reference plane RP3. The second detection electrodes 34 are arranged in the respective second regions 36. The second detection electrodes 34 respectively hold the first vibrating arm 26a and the second vibrating arm 26b between the second reference plane RP2 and the third reference plane RP3.

The conductive film 18 forms first driving electrodes 37 and second driving electrodes 38. The first driving electrodes 37 and the second driving electrodes 38 are arranged between the first and second detection electrodes 33 and 34 and free ends of the first and second vibrating arms 26a and 26b. The first driving electrodes 37 are separately fixed to the first surfaces 28 and the second surfaces 29 of the first vibrating arm 26a and the second vibrating arm 26b. The first driving electrodes 37 respectively hold the first vibrating arm 26a and the second vibrating arm 26b. The second driving electrodes 38 are separately fixed to the first side surfaces 31 and the second side surfaces 32 of the first vibrating arm 26a and the second vibrating arm 26b. The second driving electrodes 38 respectively hold the first vibrating arm 26a and the second vibrating arm 26b. The first driving electrodes 37 are formed asymmetrically with respect to equally dividing planes DP1 on the first surfaces 28. The equally dividing planes DP1 are equivalent to imaginary planes that are parallel to the plane of symmetry 27a and bisect the first surfaces 28. Similarly, the first driving electrodes 37 are formed asymmetrically with respect to equally dividing planes DP2 on the second surfaces 29. The equally dividing planes DP2 are equivalent to imaginary planes that are parallel to the plane of symmetry 27b and bisect the second surfaces 29. The second driving electrodes 38 are formed rotation-symmetrically around the axes of the first vibrating arm 26a and the second vibrating arm 26b.

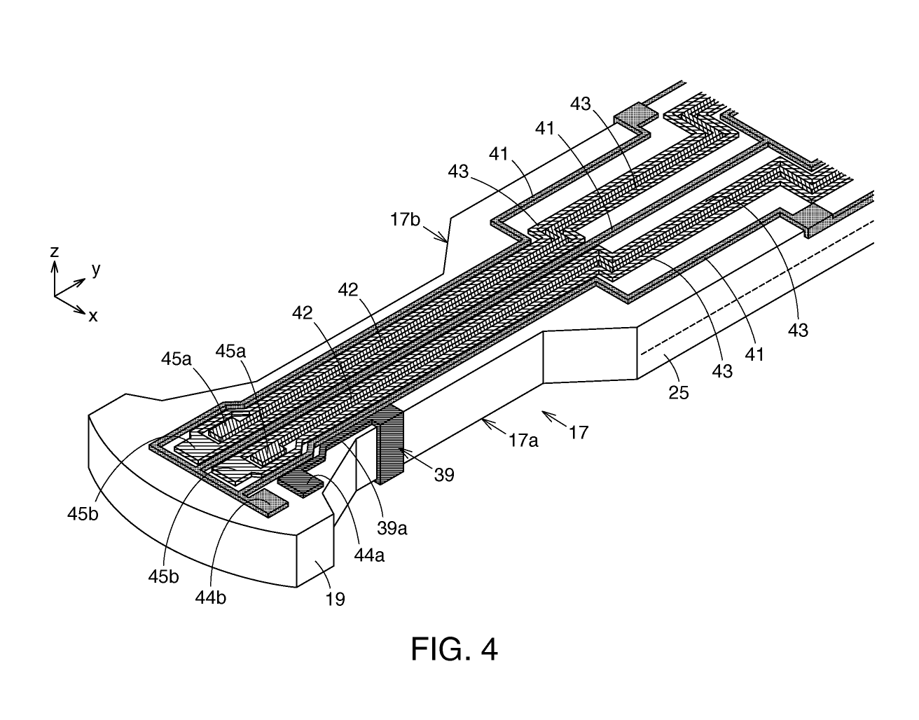

As shown in FIG. 4, the conductive film 18 forms a first detection wire 39 and second detection wires 41. The first detection wire 39 includes a front side wire and a rear side wire 39a. The front side wire is fixed to the front surface 17a of the main body 17. The rear side wire 39a is fixed to the rear surface 17b of the main body 17. The front side wire is connected to the respective first detection electrodes 33 from the first surfaces 28 of the first and second vibrating arms 26a and 26b. The rear side wire 39a extends from the base 25 to the fixing section 19. The front side wire and the rear side wire 39a are connected to each other on the side surface of the base 25.

The second detection wires 41 are fixed to the rear surface 17b of the main body 17. The second detection wires 41 are connected to the respective second detection electrodes 34 from the rear surface 17b of the main body 17. The second detection wires 41 extend from the respective second detection electrode 34 to the fixing section 19.

The conductive film 18 forms first driving wires 42 and second driving wires 43. The first driving wires 42 and the second driving wires 43 are respectively fixed to the rear surface 17b of the main body 17. The first and second driving wires 42 and 43 extend on the rear surface 17b of the main body 17. The first driving wires 42 are connected to the respective first driving electrodes 37. The second driving wires 43 are connected to the respective second driving electrodes 38. The first driving wires 42 extend from the respective first driving electrodes 37 to the fixing section 19. The second driving wires 43 extend from the respective second driving electrodes 38 to the fixing section 19.

The connection terminal group 21 includes a first detection terminals 44 and a second detection terminal 44b. The first and second detection terminals 44a and 44b are respectively fixed to the rear surface 17b of the main body 17 in the fixing section 19. The rear side wire 39a of the first detection wire 39 is connected to the first detection terminal 44a. The second detection wires 41 are connected to the second detection terminal 44b. Consequently, the first detection terminal 44a is connected to the first detection electrodes 33. The second detection terminal 44b is connected to the second detection electrodes 34. The first and second detection terminals 44a and 44b are formed as conductive material pads.

The connection terminal group 21 includes first driving terminals 45a and second driving terminals 45b. The first and second driving terminals 45a and 45b are respectively fixed to the rear surface 17b of the main body 17 in the fixing section 19. The first driving wires 42 are connected to the first driving terminals 45a. The second driving wires 43 are connected to the second driving terminals 45b. Consequently, the first driving terminals 45a are connected to the first driving electrodes 37. The second driving terminals 45b are connected to the second driving electrodes 38. The first and second driving terminals 37 and 38 are formed as conductive material pads.

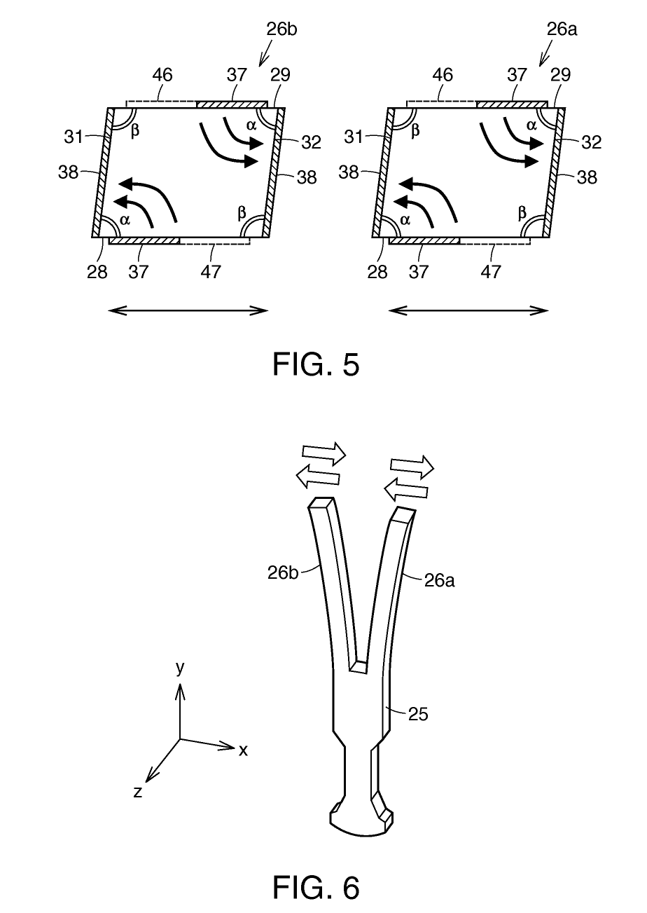

As shown in FIG. 3, the first driving electrodes 37 include notches 46 on the second surfaces 29 of the first and second vibrating arms 26a and 26b. In the notches 46, the conductive film 18 is removed from the surfaces of the first and second vibrating arms 26a and 26b. The surfaces of the first and second vibrating arms 26a and 26b are exposed instead of the conductive film 18 in the ranges of the notches 46. The notches 46 narrow the areas of the first driving electrodes 37 on the second surfaces 29. The contours of the first driving electrodes 37 are changed on the second surfaces 29. On the second surfaces 29 of the first and second vibrating arms 26a and 26b, a distance between the first driving electrodes 37 and the first side surfaces 31 is expanded compared with a distance between the first driving electrodes 37 and the second side surfaces 32. Therefore, as shown in FIG. 5, in the first and second vibrating arms 26a and 26b, a piezoelectric effect between the first driving electrodes 37 and the second driving electrodes 38 on the first side surfaces 31 is weakened compared with a piezoelectric effect between the first driving electrodes 37 and the second driving electrodes 38 on the second side surfaces 32.

Similarly, the first driving electrodes 37 include notches 47 on the first surfaces 28 of the first and second vibrating arms 26a and 26b. In the notches 47, the conductive film 18 is removed from the surfaces of the first and second vibrating arms 26a and 26b. The surfaces of the first and second vibrating arms 26a and 26b are exposed instead of the conductive film 18 in the ranges of the notches 47. The notches 47 narrow the areas of the first driving electrodes 37 on the first surfaces 28. The contour of the first driving electrodes 37 is changed on the first surfaces 28. On the first surfaces 28 of the first and second vibrating arms 26a and 26b, a distance between the first driving electrodes 37 and the second side surfaces 32 is expanded compared with a distance between the first driving electrodes 37 and the first side surfaces 31. Therefore, in the first and second vibrating arms 26a and 26b, a piezoelectric effect between the first driving electrodes 37 and the second driving electrodes 38 on the second side surfaces 32 is weakened compared with a piezoelectric effect between the first driving electrodes 37 and the second driving electrodes 38 on the first side surfaces 31.

### (2) Operation of the Gyro Sensor According to the First Embodiment

The operation of the gyro sensor 11 is briefly explained below. As shown in FIG. 6, in detection of an angular velocity, vibration is excited by the first and second vibrating arms 26a and 26b. In the excitation of the vibration, driving signals are input to the vibrating piece 15 from the first driving terminals 45a and the second driving terminals 45b. As a result, an electric field acts on the main body 17 of the vibrating piece 15 between the first driving electrodes 37 and the second driving electrodes 38. When a waveform having a specific frequency is input, the first and second vibrating arms 26a and 26b perform a bending motion in parallel to an xy plane between the first reference plane RP1 and the second reference plane RP2. The first and second vibrating arms 26a and 26b repeatedly move apart from and come close to each other, i.e., so-called in-plane vibration is caused. As it is evident from the above, the first and second reference planes RP1 and RP2 are equivalent to the directions of excited vibration of the first and second vibrating arms 26a and 26b.

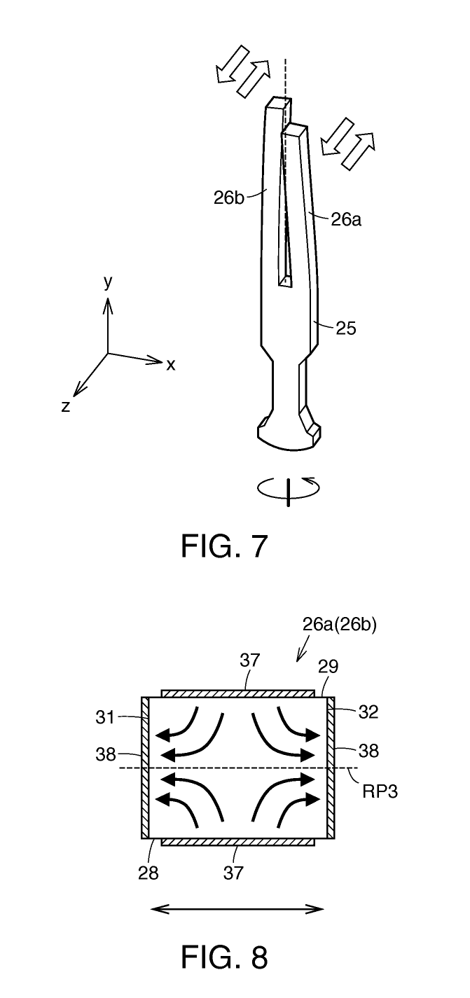

When an angular velocity motion is applied to the gyro sensor 11 around a y axis, as shown in FIG. 7, vibrating directions of the first and second vibrating arms 26a and 26b are changed by the act of the Coriolis force. At this point, a force component is generated anew in parallel to a yz plane according to the Coriolis force. In the first and second vibrating arms 26a and 26b, electric fields are generated on the basis of the piezoelectric effect between the first detection electrodes 33 and the second detection electrodes 34 according to the bending motion. Electric charges are generated. A potential difference is caused between the first detection terminal 44a and the second detection terminal 44b.

As shown in FIG. 5, in the first and second vibrating arms 26a and 26b, the first side surfaces 31 cross the first surfaces 28 at a first crossing angle α and cross the second surfaces 29 at a second crossing angle β larger than the first crossing angle α. Similarly, the first side surfaces 31 cross the second surfaces 29 at the first crossing angle α and cross the first surfaces 28 at the second crossing angle β. The notches 47 and 46 are formed in the first driving electrodes 37 on the first surfaces 28 and the second surfaces 29. Therefore, the spread of the first driving electrodes 37 is adjusted. The range of a voltage acting on the piezoelectric body from the first driving electrodes 37 is adjusted. Consequently, the vibrating directions of the first and second vibrating arms 26a and 26b are adjusted. Although the second crossing angle β is large compared with the first crossing angle α, vibration leakage can be eliminated. In a state in which the angular velocity motion does not act on the vibrating piece 15, the first and second vibrating arms 26a and 26b can vibrate in parallel to the xy plane. Oblique vibration is eliminated in the state in which the angular velocity motion does not act on the vibrating piece 15. The influence of the vibration leakage can be avoided in potentials, i.e., detection signals output from the first and second detection electrodes 33 and 34. As a result, an S/N ratio of an output signal is improved. The notches may be formed in the second driving electrodes 38 instead of in the first driving electrodes 37 or may be formed in the second driving electrodes 38 as well as in the first driving electrodes 37.

As shown in FIG. 8, when the orthogonality of the first side surfaces 31 and the second side surfaces 32 is secured with respect to the first surfaces 28 and the second surfaces 29 in the first and second vibrating arms 26a and 26b, the first and second vibrating arms 26a and 26b can perform the bending motion in parallel to the xy plane. The occurrence of the vibration leakage can be avoided. In this case, the notches do not need to be formed in the first and second driving electrodes 37 and 38.

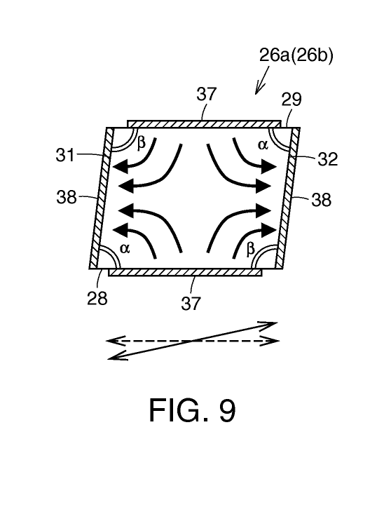

For example, as shown in FIG. 9, when the orthogonality of first side surfaces 31 and the second side surfaces 32 collapses with respect to the first surfaces 28 and the second surfaces 29 in the first and second vibrating arms 26a and 26b, the oblique vibration is caused in the first and second vibrating arms 26a and 26b even in a state in which the angular velocity motion is not applied to the vibrating piece 15, i.e., so-called vibration leakage occurs. When the angular velocity motion is applied to the vibrating piece 15 around the y axis, a component of the vibration leakage is superimposed on a force component equivalent to the Coriolis force in detection signals from the first and second detection terminals 44a and 44b. As a result, an S/N ratio of a detection signal is deteriorated.

In the first embodiment, the first surfaces 28 and the second surfaces 29 of the first and second vibrating arms 26a and 26b are equivalent to plate surfaces. Therefore, the first electrodes 37 can be easily machined from directions orthogonal to the first surfaces 28 and the second surfaces 29. The notches 46 and 47 can be easily formed. For example, a shadow can be prevented from being formed in the application of the lithography technique. Labor and time for machining can be minimized.

### (3) Manufacturing Method for the Gyro Sensor According to the First Embodiment

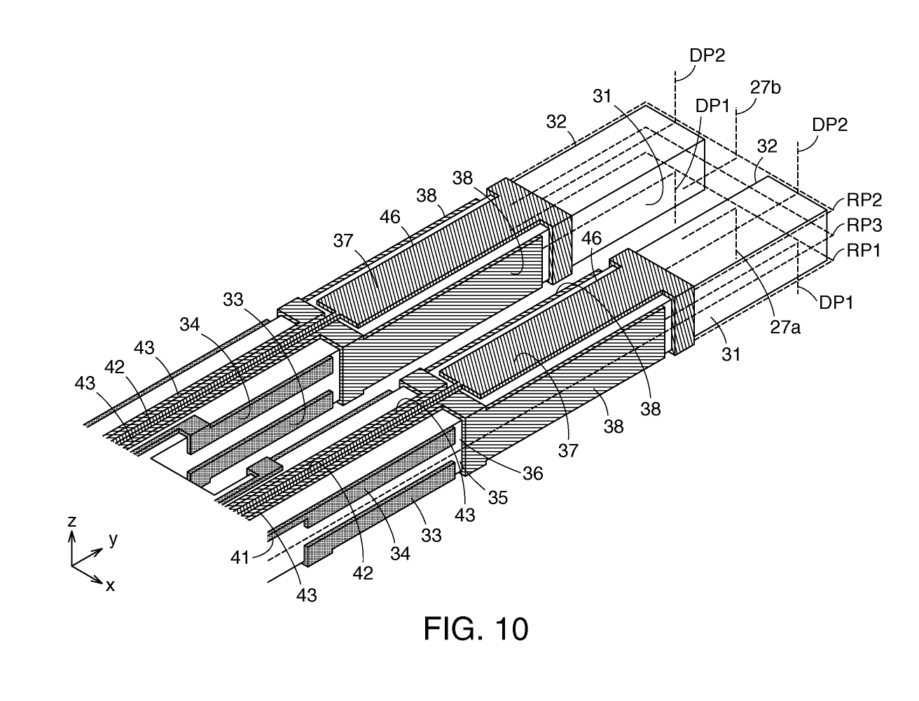

The vibrating piece 15 is manufactured in the manufacturing of the gyro sensor 11. The main body 17 of the vibrating piece 15 is scraped from a crystal body. The conductive film 18 is formed on the main body 17. As shown in FIG. 10, the conductive film 18 is formed in a pattern as designed. The first driving electrodes 37 are respectively formed plane-symmetrically with respect to the equally dividing planes DP1 and DP2 on the first surfaces 28 and the second surfaces 29. In the formation of the conductive film 18, for example, the photolithography technique can be used.

The container 12 is prepared. The IC chip 16 is fixedly attached in the container main body 13. Subsequently, the vibrating piece 15 is fixedly attached in the container main body 13. The connection terminal group 21 is joined to the conductive terminal group 22. The first and second detection terminals 44a and 44b and the first and second driving terminals 45a and 45b are respectively received by connection terminals corresponding thereto. Consequently, the vibrating piece 15 is electrically connected to the IC chip 16.

Tuning of the gyro sensor 11 is carried out. In the tuning, a control signal is supplied to the IC chip 16. The IC chip 16 starts a detecting operation for an angular velocity. As explained above, vibration is excited by the first and second vibrating arms 26a and 26b. If an angular velocity motion does not act, the Coriolis force is not generated in the first and second vibrating arms 26a and 26b. At this point, if angular velocity=“0 (zero)” is detected by the gyro sensor 11, the opening of the container main body 13 is hermetically closed by the lid member 14. The internal space of the container 12 is sealed. The manufacturing of the gyro sensor 11 is completed.

If angular velocity=“0” is not detected by the gyro sensor 11, the first driving electrodes 37 are partially removed according to a measured charge amount. The notches 47 and 46 are formed in the first driving electrodes 37 on the first surfaces 28 and the second surfaces 29. In the removal, for example, a laser can be used. Laser traces are formed on the contours of the first driving electrodes 37. As a result, if angular velocity=“0 (zero)” is detected by the gyro sensor 11, the opening of the container main body 13 is hermetically closed by the lid member 14. The internal space of the container 12 is sealed. The manufacturing of the gyro sensor 11 is completed.

### (4) Gyro Sensor According to a Second Embodiment

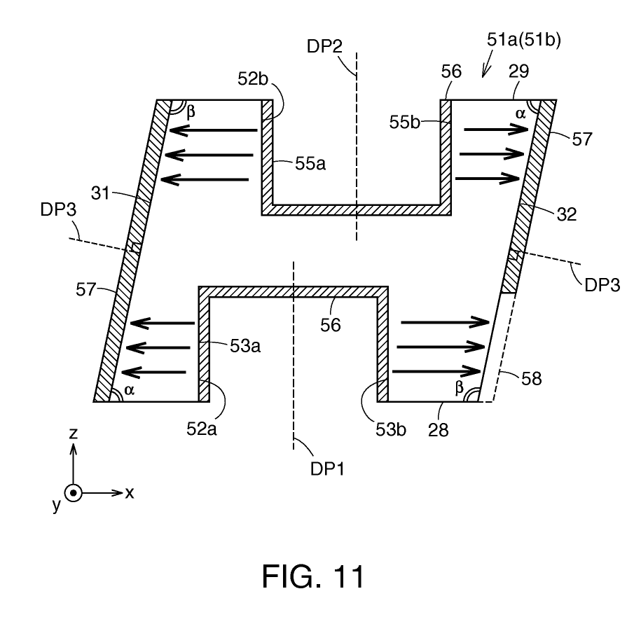

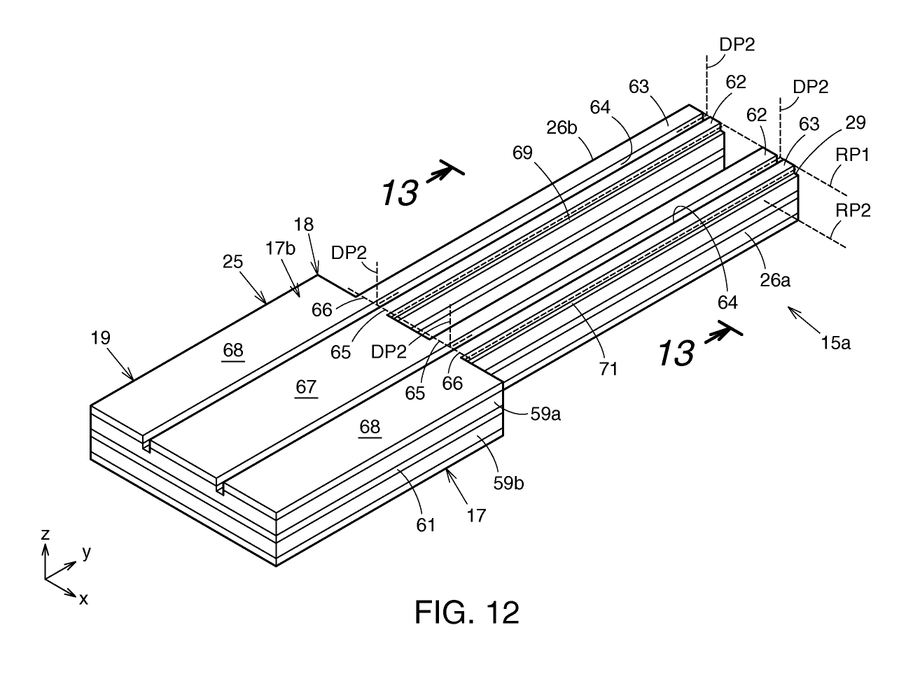

In the gyro sensor 11 according to a second embodiment, first and second vibrating arms 51a and 51b are used in the vibrating piece 15 instead of the first and second vibrating arms 26a and 26b. As shown in FIG. 11, first grooves 52a are formed on the first surfaces 28 of the first and second vibrating arms 51a and 51b and second grooves 52b are formed on the second surfaces 29 of the first and second vibrating arms 51a and 51b. The first grooves 52a and the second grooves 52b extend in the longitudinal direction of the first and second vibrating arms 51a and 51b. The first grooves 52a and the second grooves 52b can be formed as long grooves extending over the entire length of the first and second vibrating arms 51a and 51b.

The first grooves 52a include first wall surfaces 53a and second wall surfaces 53b. The first wall surfaces 53a and the second wall surfaces 53b face each other. Piezoelectric bodies of the first and second vibrating arms 51a and 51b are partitioned between the first wall surfaces 53a and the first side surfaces 31. The piezoelectric bodies of the first and second vibrating arms 51a and 51b are partitioned between the second wall surfaces 53b and the second side surfaces 32. The first wall surfaces 53a and the second wall surfaces 53b only have to spread in parallel to the equally dividing planes DP1. In addition, the first wall surfaces 53a and the second wall surfaces 53b can be formed plane-symmetrically with respect to the equally dividing planes DP1.

The second grooves 52b include third wall surfaces 55a and fourth wall surfaces 55b. The third wall surfaces 55a and the fourth wall surfaces 55b face each other. The piezoelectric bodies of the first and second vibrating arms 51a and 51b are partitioned between the third wall surfaces 55a and the first side surfaces 31. The piezoelectric bodies of the first and second vibrating arms 51a and 51b are partitioned between the fourth wall surfaces 55b and the second side surfaces 32. The third wall surfaces 55a and the fourth wall surfaces 55b only have to spread in parallel to the equally dividing planes DP2. In addition, the third wall surfaces 55a and the fourth wall surfaces 55b can be formed plane-symmetrically with respect to the equally dividing planes DP2.

First driving electrodes 56 and second driving electrodes 57 are fixed to the first and second vibrating arms 51a and 51b. The first driving electrodes 56 are arranged in the first and second grooves 52a and 52b of the first and second vibrating arms 51a and 51b. The first driving electrodes 56 respectively cover the first to fourth wall surfaces 53a, 53b, 55a, and 55b in the first and second grooves 52a and 52b. The first driving electrodes 56 are connected to the first driving wires 42 and the first driving terminals 45a.

The second driving electrodes 57 are arranged on the first and second side surfaces 31 and 32 of the first and second vibrating arms 51a and 51b. The second driving electrodes 57 at least partially cover the first and second side surfaces 31 and 32. The second driving electrodes 57 are connected to the second driving wires 43 and the second driving terminals 45b. The second driving electrodes 57 are formed asymmetrically with respect to equally dividing planes DP3 on the second side surfaces 32. The equally dividing planes DP3 are orthogonal to the first side surfaces 31 and the second side surfaces 32 on bisectors of the first side surfaces 31 and the second side surfaces 32 at an equal distance from the first planes 28 and the second planes 29.

The second driving electrodes 57 include notches 58 on the second side surfaces 32. In the notches 58, the conductive film 18 is removed from the surfaces of the first and second vibrating arms 51a and 51b. The surfaces of the first and second vibrating arms 51a and 51b are exposed instead of the conductive film 18 in the ranges of the notches 58. The notches 58 narrow the areas of the second driving electrodes 57 on the second side surfaces 32. The contours of the second driving electrodes 57 are changed on the second side surfaces 32. The piezoelectric bodies held between the second driving electrodes 57 on the second side surfaces 32 and the first driving electrodes 56 on the second wall surfaces 53b decrease. In the notches 58, a piezoelectric effect is not caused between the second wall surfaces 53b and the second side surfaces 32. The other components can be configured the same as the components in the first embodiment. Components and structures equivalent to those in the first embodiment are denoted by the same reference numerals and signs and detailed explanation of the components and the structures is omitted.

When an angular velocity motion is applied to the gyro sensor 11 around the y axis, vibrating directions of the first and second vibrating arms 51a and 51b are changed by the act of the Coriolis force, i.e., so-called oblique vibration is caused. At this point, a force component is generated anew in parallel to the yz plane according to the Coriolis force. In the first and second vibrating arms 51a and 51b, electric fields are generated on the basis of the piezoelectric effect between the first detection electrodes 33 and the second detection electrodes 34 according to the bending motion. Electric charges are generated. A potential difference is caused between the first detection terminal 44a and the second detection terminal 44b.

As shown in FIG. 11, in the first and second vibrating arms 51a and 51b, the first side surfaces 31 cross the first surfaces 28 at the first crossing angle α and cross the second surfaces 29 at the second crossing angle β larger than the first crossing angle α. Similarly, the second side surfaces 32 cross the second surfaces 29 at the first crossing angle α and cross the first surfaces 28 at the second crossing angle β. The notches 58 are formed in the second driving electrodes 57 on the second side surfaces 32. Therefore, the spread of the second driving electrodes 57 is adjusted. The range of a voltage acting on the piezoelectric body from the second driving electrodes 57 is adjusted. Consequently, the vibrating directions of the first and second vibrating arms 51a and 51b are adjusted. Although the second crossing angle β is large compared with the first crossing angle a, vibration leakage can be eliminated. In a state in which the angular velocity motion does not act on the vibrating piece 15, the first and second vibrating arms 51a and 51b can vibrate in parallel to the xy plane. The oblique vibration is eliminated in the state in which the angular velocity motion does not act on the vibrating piece 15. The influence of the vibration leakage can be avoided in potentials, i.e., detection signals output from the first and second detection electrodes 33 and 34. As a result, an S/N ratio of an output signal is improved. The notches may be formed in the second driving electrodes 57 on the first side surfaces 31, may be formed in the first driving electrodes 56 instead of in the second driving electrodes 57, or may be formed in the first driving electrodes 56 as well as in the second driving electrodes 57.

In the second embodiment, since the piezoelectric bodies are held between the first driving electrodes 56 and the second driving electrodes 57, excitation efficiency is improved compared with excitation efficiency obtained when driving electrodes are adjacent to each other across a ridge line. Therefore, the effect of the notches 58 is improved. The oblique vibration can be suppressed (or eliminated) by as little machining as possible.

### (5) Gyro Sensor According to a Third Embodiment

In the gyro sensor 11 according to a third embodiment, a vibrating piece 15a is used instead of the vibrating piece 15. As shown in FIG. 12, the main body 17 of the vibrating piece 15a includes a pair of piezoelectric substrates 59a and 59b and an internal electrode 61. The piezoelectric substrates 59a and 59b are laid one on top of the other. The internal electrode 61 is held between the piezoelectric substrates 59a and 59b. The piezoelectric substrates 59a and 59b are formed of, for example, lead zirconate titanate (PZT). The internal electrode 61 can be formed of a conductive material such as gold (Au), copper (Cu), or other kinds of metal. The piezoelectric substrates 59a and 59b are polarized in opposite directions each other in the thickness direction.

The conductive film 18 is fixed to the rear surface 17b of the main body 17. The conductive film 18 forms first electrodes 62 and second electrodes 63. The first electrodes 62 and the second electrodes 63 are fixed to the second surfaces 29 of the first and second vibrating arms 26a and 26b. The piezoelectric substrate 59a is held between the first and second electrodes 62 and 63 and the internal electrode 61. The first electrodes 62 and the second electrodes 63 can spread in parallel to the surface of the internal electrode 61. The first electrodes 62 and the second electrodes 63 extend over the entire length of the first and second vibrating arms 26a and 26b from the roots to the free ends of the first and second vibrating arms 26a and 26b.

Long grooves 64 are formed between the first electrodes 62 and the second electrodes 63. The long grooves 64 separate the second electrodes 63 from the first electrodes 62. The first electrodes 62 are arranged in first regions 65 of the second surfaces 29. The second electrodes 63 are arranged in the second regions 66 of the second surfaces 29. The equally dividing planes DP2 bisect the second surfaces 29 into the first regions 65 and second regions 66. The long grooves 64 extend over the entire length of the first and second vibrating arms 26a and 26b along the equally dividing planes DP2. The long grooves 64 are formed symmetrically with respect to the equally dividing planes DP2.

The conductive film 18 forms a first wire 67 and a pair of second wires 68. The first wire 67 and the second wires 68 are fixed to the rear surface 17b of the main body 17 in the fixing section 19 and the base 25. The first wire 67 is connected to the first electrodes 62. The respective second wires 68 are separately connected to the second electrodes 63. The long grooves 64 longitudinally cross the base 25 and the fixing section 19. The long grooves 64 separate the respective second wires 68 from the first wire 67. The first wire 67 and the second wires 68 are connected to connection terminals corresponding thereto in the conductive terminal group 22.

The first electrodes 62 include a notch 69 on the second surface 29 of the second vibrating arm 26b. In the notch 69, the conductive film 18 is removed from the surface of the second vibrating arm 26b. The surface of the second vibrating arm 26b is exposed instead of the conductive film 18 in the range of the notch 69. The notch 69 narrows the area of the first electrode 62 on the second surface 29. The contour of the first electrode 62 is changed on the second surface 29. In the second vibrating arm 26b, the piezoelectric body held between the first electrode 62 on the second surface 29 and the internal electrode 61 decreases. In the second vibrating arm 26b, a piezoelectric effect of the first electrode 62 is weakened.

The second electrode 63 includes a notch 71 on the second surface 29 of the first vibrating arm 26a. In the notch 71, the conductive film 18 is removed from the surface of the first vibrating arm 26a. The surface of the first vibrating arm 26a is exposed instead of the conductive film 18 in the range of the notch 71. The notch 71 narrows the area of the second electrode 63 on the second surface 29. The contour of the second electrode 63 is changed on the second surface 29. In the first vibrating arm 26a, the piezoelectric body held between the second electrode 63 on the second surface 29 and the internal electrode 61 decreases. Consequently, in the first vibrating arm 26a, a piezoelectric effect of the second electrode 63 is weakened. The other components can be configured the same as the components in the first and second embodiments. Components and structures equivalent to those in the first and second embodiments are denoted by the same reference numerals and signs and detailed explanation of the components is omitted.

The operation of the gyro sensor 11 is briefly explained below. In detection of an angular velocity, vibration is excited by the first and second vibrating arms 26a and 26b. In the excitation of the vibration, driving signals are input to the vibrating piece 15a from the first wire 67 and the second wires 68. As a result, an electric field acts on the main body 17 of the vibrating piece 15a between the first electrodes 62 and the second electrodes 63. When a waveform having a specific frequency is input, the first and second vibrating arms 26a and 26b perform a bending motion in parallel to the xy plane between the first reference plane RP1 and the second reference plane RP2. The first and second vibrating arms 26a and 26b repeatedly move apart from and come close to each other, i.e., so-called in-plane vibration is caused.

When an angular velocity motion is applied to the gyro sensor 11 around the y axis, vibrating directions of the first and second vibrating arms 26a and 26b are changed by the act of the Coriolis force, i.e., so-called oblique vibration is caused. At this point, a force component is generated anew in parallel to the yz plane according to the Coriolis force. In the first and second vibrating arms 26a and 26b, electric fields are generated on the basis of the piezoelectric effect between the second electrodes 63 and the internal electrodes 61 according to the bending motion. Electric charges are generated. Potentials are extracted from the respective second wires 68.

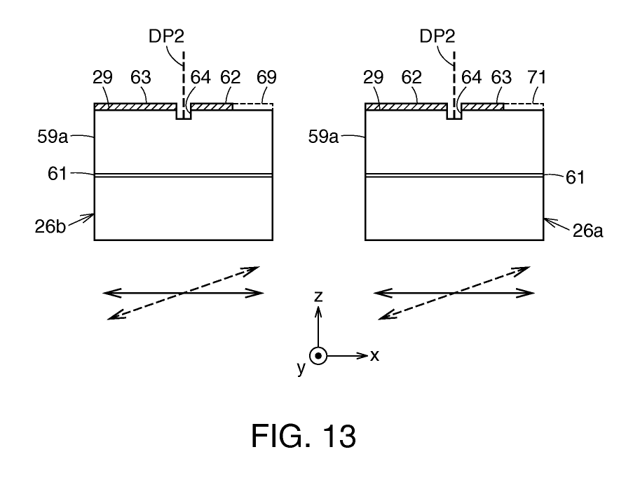

As shown in FIG. 13, since the notch 71 is formed in the second electrode 63 in the first vibrating arm 26a, the spread of the second electrode 63 is adjusted. A range of a voltage acting on the piezoelectric body from the second electrode 63 is adjusted. Consequently, a vibrating direction of the first vibrating arm 26a is adjusted. Similarly, since the notch 69 is formed in the first electrode 62 in the second vibrating arm 26b, the spread of the first electrode 62 is adjusted. A range of a voltage acting on the piezoelectric body from the first electrode 62 is adjusted. Consequently, a vibrating direction of the second vibrating arm 26b is adjusted. As a result, vibration leakage based on a machining error can be eliminated. In a state in which an angular velocity motion does not act on the vibrating piece 15a, the first and second vibrating arms 26a and 26b can vibrate in parallel to the xy plane. The oblique vibration is eliminated in the state in which the angular velocity motion does not act on the vibrating piece 15a. The influence of the vibration leakage is avoided in potentials, i.e., detection signals output from the first and second electrodes 62 and 63. As a result, an S/N ratio of an output signal is improved. On the other hand, if the first electrodes 62 and the second electrodes are formed symmetrically with respect to the equally dividing planes DP2 in the respective vibrating arms 26a and 26b, in other words, if the notches 69 and 71 are not formed in the first electrodes 62 and the second electrodes 63, even in the state in which an angular velocity motion does not act on the vibrating piece 15a, the first and second vibrating arms 26a and 26b vibrate in parallel to a plane rotated around the y axis at a predetermined angle from the xy plane, i.e., a so-called oblique vibration is caused.

In the third embodiment, the second surfaces 29 of the first and second vibrating arms 26a and 26b are equivalent to plate surfaces. Therefore, the first electrodes 62 and the second electrodes 63 can be easily machined from a direction orthogonal to the second surfaces 29. The notches 69 and 71 can be easily formed. For example, a shadow can be prevented from being formed in the application of the lithography technique. Labor and time for machining can be minimized.

### (6) Configuration of a Gyro Sensor According to a Fourth Embodiment

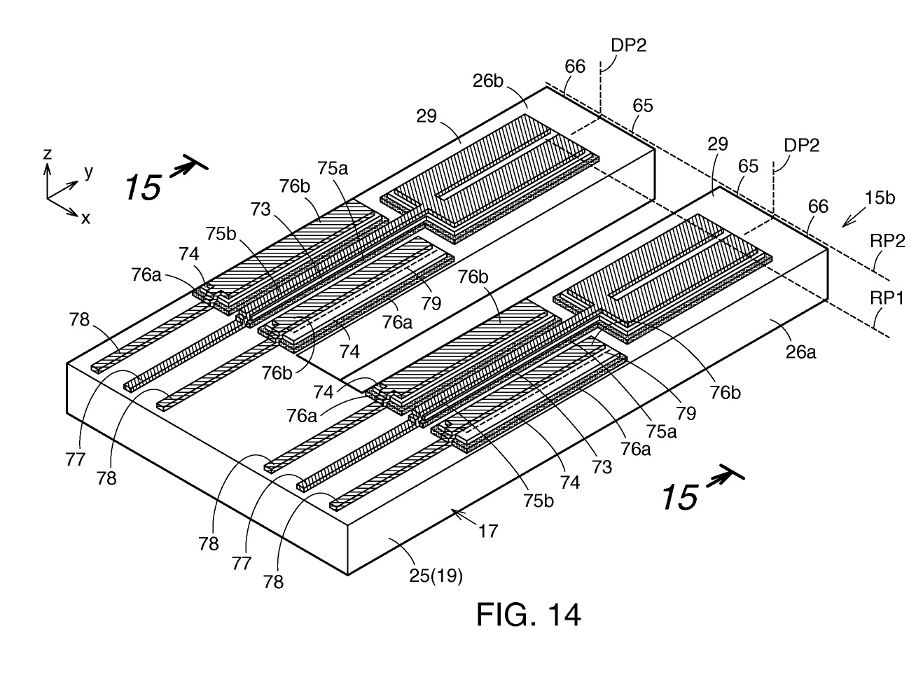

In the gyro sensor 11 according to a fourth embodiment, a vibrating piece 15b is used instead of the vibrating piece 15 explained above. As shown in FIG. 14, the main body 17 of the vibrating piece 15b is formed of a non-piezoelectric body. The main body 17 is formed of, for example, silicon (Si).

Piezoelectric films for detection 73 and pairs of piezoelectric films for driving 74 are fixed to the second surfaces 29 of the first and second vibrating arms 26a and 26b. The piezoelectric films for detection 73 and the piezoelectric films for driving 74 can be formed by piezoelectric bodies such as lead zirconate titanate (PZT). One piezoelectric films for driving 74 are arranged in the first regions 65 of the second surfaces 29. The other piezoelectric films for driving 74 are arranged in the second regions 66 of the second surfaces 29. The equally dividing planes DP2 bisect the second surfaces 29 into the first regions 65 and the second regions 66. Gaps extend along the equally dividing planes DP2 between the piezoelectric films for driving 74. The piezoelectric films for driving 74 are separated along the equally dividing planes DP2. The piezoelectric films for driving 74 are formed symmetrically with respect to the equally dividing planes DP2. The piezoelectric films for detection 73 are arranged between the piezoelectric films for driving 74. The piezoelectric films for detection 73 are separated from the piezoelectric films for driving 74. The piezoelectric films for detection 73 extend along the equally dividing planes DP2.

The conductive film 18 forms first detection electrodes 75a and second detection electrodes 75b and first driving electrodes 76a and second driving electrodes 76b. The first detection electrodes 75a and the second detection electrodes 75b are fixed to the piezoelectric films for detection 73. The first detection electrodes 75a are held between the first and second vibrating arms 26a and 26b and the piezoelectric films for detection 73. The second detection electrodes 75b cover the surfaces of the piezoelectric films for detection 73. Consequently, the piezoelectric films for detection 73 are held between the first detection electrodes 75a and the second detection electrodes 75b. The first detection electrodes 75a and the second detection electrodes 75b are formed symmetrically with respect to the equally dividing planes DP2.

The first driving electrodes 76a and the second driving electrodes 76b are fixed to the piezoelectric films for driving 74. The first driving electrodes 76a are held between the first and second vibrating arms 26a and 26b and the piezoelectric films for driving 74. The second driving electrodes 76b cover the surfaces of the piezoelectric films for driving 74. Consequently, the piezoelectric films for driving 74 are held between the first driving electrodes 76a and the second driving electrodes 76b. The first driving electrodes 76a are formed symmetrically with respect to the equally dividing planes DP2. On the other hand, the second driving electrodes 76b are formed asymmetrically with respect to the equally dividing planes DP2.

The conductive film 18 forms detection wires 77 and driving wires 78. The detection wires 77 and the driving wires 78 are fixed to the rear surface 17b of the main body 17. The detection wires 77 are connected to the second detection electrodes 75b. The detection wires 77 extend from the second detection electrodes 75b to the base 25 (the fixing section 19). The detection wires 77 are connected to connection terminals corresponding thereto in the conductive terminal group 22. The driving wires 78 are connected to the second driving electrodes 76b. The driving wires 78 extend from the second driving electrodes 76b to the base 25 (the fixing section 19). The driving wires 78 are joined to connection terminals corresponding thereto in the conductive terminal group 22. The driving wires 78 are electrically insulated from the detection wires 77.

The second driving electrodes 76b include notches 79. In the notches 79, the conductive film 18 is removed from the surfaces of the piezoelectric films for driving 74. The surfaces of the piezoelectric films for driving 74 are exposed instead of the conductive film 18 in the ranges of the notches 79. The notches 79 narrow the areas of the second driving electrodes 76b on the piezoelectric films for driving 74. The contours of the second driving electrodes 76b are changed on the piezoelectric films for driving 74. The piezoelectric films for driving 74 held between the first driving electrodes 76a and the second driving electrodes 76b on the second surface 29 decrease in the first driving arm 26a. A piezoelectric effect of the second driving electrodes 76b is weakened on the piezoelectric films for driving 74. The other components can be formed the same as the components in the first to third embodiments explained above. Components and structures equivalent to those in the first to third embodiments are denoted by the same reference numerals and signs and detailed explanation of the components and the structures is omitted.

### (7) Operation of the Gyro Sensor According to the Fourth Embodiment

The operation of the gyro sensor 11 is briefly explained below. In detection of an angular velocity, vibration is excited by the first and second vibrating arms 26a and 26b. In the excitation of the vibration, driving signals are input to the vibrating piece 15b from the driving wires 78. As a result, an electric field acts on the piezoelectric films for driving 74 between the first driving electrodes 76a and the second driving electrodes 76b. The first driving electrodes 76a function as ground electrodes. When a waveform having a specific frequency is input, the first and second vibrating arms 26a and 26b perform a bending motion in parallel to the xy plane between the first reference plane RP1 and the second reference plane RP2. The first and second vibrating arms 26a and 26b repeatedly move apart from and come close to each other, i.e., so-called in-plane vibration is caused.

When an angular velocity motion is applied to the gyro sensor 11 around the y axis, vibrating directions of the first and second vibrating arms 26a and 26b are changed by the act of the Coriolis force, i.e., so-called oblique vibration is caused. At this point, a force component is generated anew in parallel to the yz plane according to the Coriolis force. In the first and second vibrating arms 26a and 26b, electric fields are generated on the basis of the piezoelectric effect between the first detection electrodes 75a and the second detection electrodes 75b according to the bending motion. Electric charges are generated. Potentials are extracted from the respective detection wires 77. The first detection electrodes 75a function as ground electrodes.

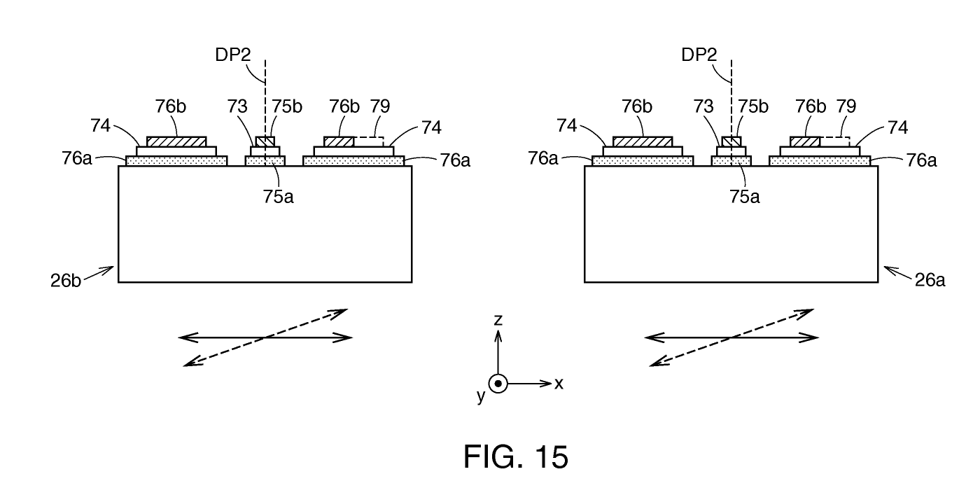

As shown in FIG. 15, in the first and second vibrating arms 26a and 26b, since the notches 79 are formed in the second driving electrodes 76b, the spread of the second driving electrodes 76b is adjusted. A range of a voltage acting on the piezoelectric films for driving 74 from the second driving electrodes 76b is adjusted. Consequently, vibrating directions of the first and second vibrating arms 26a and 26b are adjusted. As a result, vibration leakage based on a machining error can be eliminated. In a state in which an angular velocity motion does not act on the vibrating piece 15b, the first and second vibrating arms 26a and 26b can vibrate in parallel to the xy plane. The oblique vibration is eliminated in the state in which the angular velocity motion does not act on the vibrating piece 15b. The influence of the vibration leakage is avoided in potentials, i.e., detection signals output from the second detection electrodes 75b. As a result, an S/N ratio of an output signal is improved. In the formation of the vibrating piece 15b, an MEMS (Micro Electro Mechanical Systems) technique can be used. On the other hand, if the second driving electrodes 76b are formed symmetrically with respect to the equally dividing planes DP2 in the respective vibrating arms 26a and 26b, in other words, if the notches 79 are not formed in the second driving electrodes 76b, even in the state in which an angular velocity motion does not act on the vibrating piece 15b, the first and second vibrating arms 26a and 26b vibrate in parallel to a plane rotated around the y axis at a predetermined angle from the xy plane, i.e., a so-called oblique vibration is caused.

In the fourth embodiment, the first surfaces 28 of the first and second vibrating arms 26a and 26b are equivalent to plate surfaces. Therefore, the second driving electrodes 76b can be easily machined from a direction orthogonal to the first surface 28. The notches 79 can be easily formed. For example, a shadow can be prevented from being formed in the application of the lithography technique. Labor and time for machining can be minimized.

Besides, in the forth embodiment, wires may be connected to the first detection electrodes 75a and the first driving electrodes 76a. The wires only have to be fixed to the rear surface 17b of the main body 17. In the fixing, the wires are electrically insulated from the detection wires 77 and the driving wires 78. In the insulation, insulators can be held between the wires and the detection wires 77 and between the wires and the driving wires 78. The insulators can be formed by piezoelectric bodies. The piezoelectric bodies can continue from the piezoelectric films for detection 73 and the piezoelectric films for driving 74. The wires only have to extend from the first detection electrodes 75a and the first driving electrodes 76a to the base 25 (the fixing section 19). The wires only have to be joined to connection terminals corresponding thereto in the conductive terminal group 22.

### (8) Manufacturing Method for the Gyro Sensor According to the Fourth Embodiment

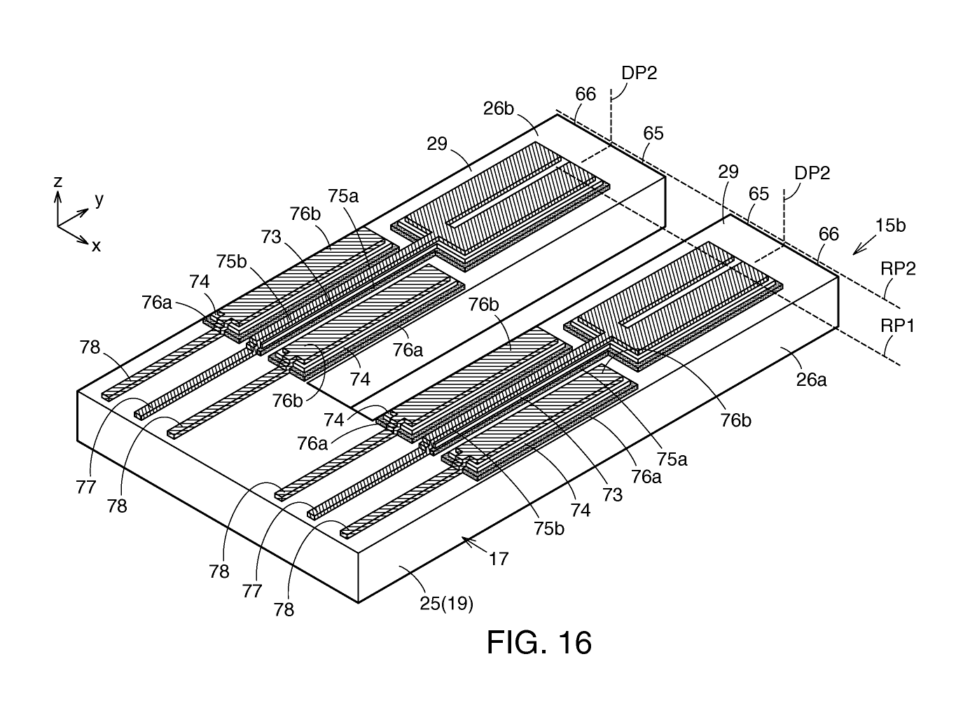

In manufacturing of the gyro sensor 11, the vibrating piece 15b is manufactured. The main body 17 of the vibrating piece 15b is scraped from a silicon substrate. The first detection electrodes 75a and the first driving electrodes 76a are formed on the rear surface 17b of the main body 17. In the formation, for example, the photolithography technique can be used. Subsequently, the piezoelectric films for detection 73 and the piezoelectric films for driving 74 are formed on the surfaces of the first detection electrodes 75a and the surfaces of the first driving electrodes 76a. In the formation of the piezoelectric films 73 and 74, for example, the MEMS technique can be used. The second detection electrodes 75b, the second driving electrodes 76b, the detection wires 77, and the driving wires 78 are formed on the surfaces of the piezoelectric films 73 and 74. As shown in FIG. 16, the second driving electrodes 76a are formed in a pattern as designed. The second driving electrodes 76b are formed plane-symmetrically with respect to the equally dividing planes DP2 on the second surfaces 29. In the formation of the conductive film 18, for example, the photolithography technique can be used.

The container 12 is prepared. The IC chip 16 is fixedly attached in the container main body 13. Subsequently, the vibrating piece 15b is fixedly attached in the container main body 13. The connection terminal group 21 is joined to the conductive terminal group 22. The detection wires 77 and the driving wires 78 are respectively received by connection terminals corresponding thereto. Consequently, the vibrating piece 15b is electrically connected to the IC chip 16.

Tuning of the gyro sensor 11 is carried out. In the tuning, a control signal is supplied to the IC chip 16. The IC chip 16 starts a detecting operation for an angular velocity. As explained above, vibration is excited by the first and second vibrating arms 26a and 26b. If an angular velocity motion does not act, the Coriolis force is not generated in the first and second vibrating arms 26a and 26b. At this point, if angular velocity=“0 (zero)” is detected by the gyro sensor 11, the opening of the container main body 13 is hermetically closed by the lid member 14. The internal space of the container 12 is sealed. The manufacturing of the gyro sensor 11 is completed.

If angular velocity=“0” is not detected by the gyro sensor 11, the second driving electrodes 76b are partially removed according to a measured charge amount. The notches 79 are formed in the second driving electrodes 76b on the second surfaces 29. In the removal, for example, a laser can be used. Laser traces are formed on the contours of the second driving electrodes 76b. As a result, if angular velocity=“0 (zero)” is detected by the gyro sensor 11, the opening of the container main body 13 is hermetically closed by the lid member 14. The internal space of the container 12 is sealed. The manufacturing of the gyro sensor 11 is completed.

### (9) Electronic Apparatus, Etc.

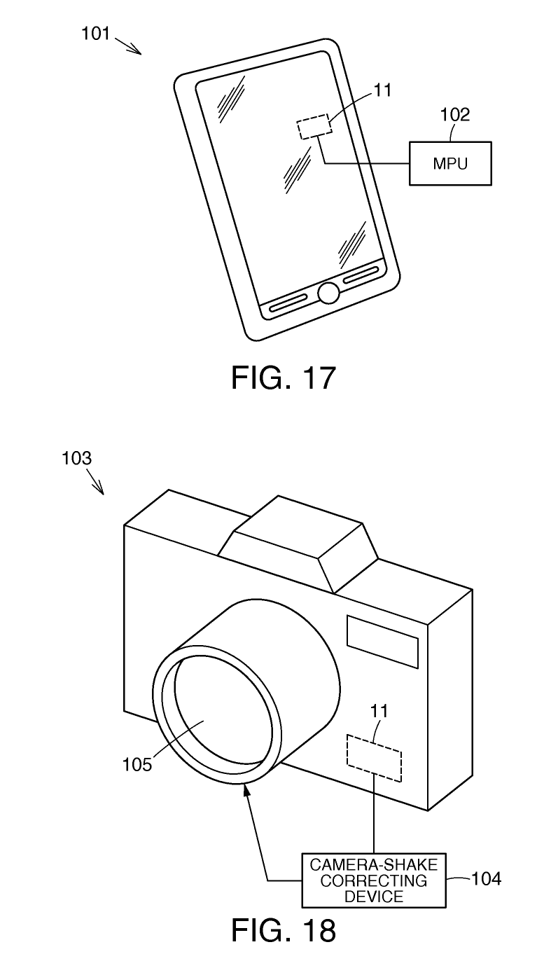

FIG. 17 schematically shows a smart phone 101, which is a specific example of an electronic apparatus. The gyro sensor 11 including the vibrating piece 15, 15a, or 15b is incorporated in the smart phone 101. The gyro sensor 11 can detect the posture of the smart phone 101. So-called motion sensing is carried out. A detection signal of the gyro sensor 11 can be supplied to, for example, a microcomputer chip (MPU) 102. The MPU 102 can execute various kinds of processing according to the motion sensing. Besides, the motion sensing can be used in electronic apparatuses such as a cellular phone, a portable game machine, a game controller, a car navigation system, a pointing device, a head-mounted display, and a tablet personal computer. In realizing the motion sensing, the gyro sensor 11 can be incorporated.

FIG. 18 schematically shows a digital still camera (hereinafter referred to as “camera”) 103, which is another specific example of the electronic apparatus. The gyro sensor 11 including the vibrating piece 15, 15a, or 15b is incorporated in the camera 103. The gyro sensor 11 can detect the posture of the camera 103. A detection signal of the gyro sensor 11 can be supplied to a camera-shake correcting device 104. The camera-shake correcting device 104 can move, for example, a specific lens in a lens set 105 according to the detection signal of the gyro sensor 11. Consequently, a camera shake can be corrected. Besides, the camera shake correction can be used in a digital video camera. In realizing the camera shake correction, the gyro sensor 11 can be incorporated.

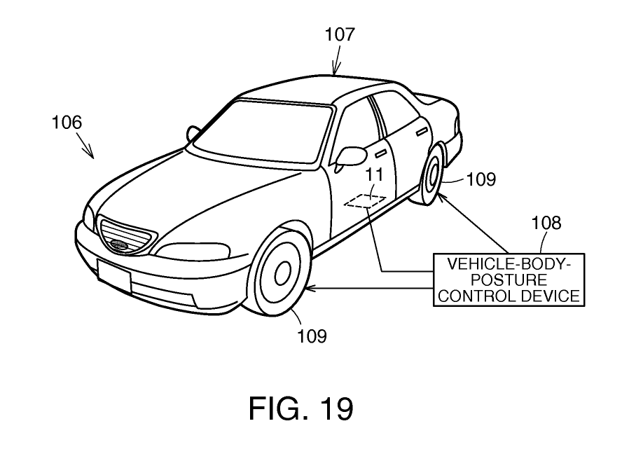

FIG. 19 schematically shows an automobile 106, which is a specific example of a mobile body. The gyro sensor 11 including the vibrating piece 15, 15a, or 15b is incorporated in the automobile 106. The gyro sensor 11 can detect the posture of a vehicle body 107. A detection signal of the gyro sensor 11 can be supplied to a vehicle-body-posture control device 108. For example, the vehicle-body-posture control device 108 can control hardness and softness of a suspension and control brakes of respective wheels 109 according to the posture of the vehicle body 107. Besides, the posture control can be used in various mobile bodies such as a biped walking robot, an airplane, and a helicopter. In realizing the posture control, the gyro sensor 11 can be incorporated.

The embodiments are explained above in detail. However, those skilled in the art could easily understand that a large number of modifications are possible without substantially departing from the new matters and the effects of the invention. Therefore, all such modifications are included in the scope of the invention. For example, in the example explained in the embodiments, quartz is used as the material forming the vibrating piece. However, a piezoelectric material other than the quartz can be used. For example, aluminum nitride (AlN), an oxide substrate of lithium niobate (LiNbO₃), lithium tantalate (LiTaO₃), lead zirconate titanate (PZT), lithium tetraborate (Li₂B₄O₇), or langasite (La₃Ga₅SiO₁₄), a laminated piezoelectric substrate formed by laminating a piezoelectric material such as aluminum nitride or tantalum pentoxide (Ta₂O₅) on a glass substrate, or piezoelectric ceramics can be used. In the specification or the drawings, the terms described together with the broader different terms or the synonymous different terms at least once can be replaced with the different terms in any places of the specification or the drawings. The configurations and the operations of the gyro sensor 11, the vibrating pieces 15, 15a, and 15b, the smart phone, the automobile, the digital still camera, and the like are not limited to those explained in the embodiment. Various modifications of the configurations and the operations are possible.

The entire disclosure of Japanese Patent Application No. 2012-106068, filed May 7, 2012 is expressly incorporated by reference herein.

What is claimed is:

1. A vibrating piece comprising:
a driving arm at least partially formed by a piezoelectric body, the driving arm including a first surface spreading along a direction of excited vibration, a second surface on an opposite side of the first surface, a first side surface configured to connect the first surface and the second surface, and a second side surface arranged on an opposite side of the first side surface and configured to connect the first surface and the second surface;
first electrodes arranged at least above one surface side of the first surface and the second surface; and
second electrodes arranged above at least one surface side of the first side surface and the second side surface, wherein
the first electrodes are provided asymmetrically with respect to an equally dividing plane of the driving arm orthogonal to the direction of the excited vibration of the driving arm.

2. The vibrating piece according to claim 1, wherein
the first electrodes are arranged above the first surface side,
the second electrodes are arranged above the first side surface side and the second side surface side, and
a distance between the first electrodes arranged above the first surface side and the second electrodes arranged above the first side surface side is shorter than a distance between the first electrodes arranged above the first surface side and the second electrodes arranged above the second side surface side.

3. The vibrating piece according to claim 2, wherein
the first electrodes are arranged above the second surface side, and
a distance between the first electrodes arranged above the second surface side and the second electrodes arranged above the second side surface side is shorter than a distance between the first electrodes arranged above the second surface side and the second electrodes arranged above the first side surface side.

4. A vibrating piece comprising:
a driving arm at least partially formed by a piezoelectric body, the driving arm including a first surface spreading along a direction of excited vibration, a second surface on an opposite side of the first surface, a first side surface configured to connect the first surface and the second surface, a second side surface arranged on an opposite side of the first side surface and configured to connect the first surface and the second surface, a groove provided on the first surface and extending in a longitudinal direction of the driving arm, the groove being a first groove including a first wall surface on the first side surface side and a second wall surface on the second side surface side, and a groove provided on the second surface and extending in the longitudinal direction of the driving arm, the groove being a second groove including a third wall surface on the first side surface side and a fourth wall surface on the second side surface side; and
first electrodes arranged above the first wall surface side, the second wall surface side, the third wall surface side, and the fourth wall surface side and second electrodes arranged on the first side surface side and the second side surface side, wherein
the second electrodes are arranged, at least above one of the first side surface side and the second side surface side, asymmetrically with respect to equally dividing planes respectively orthogonal to the first side surface and the second side surface on bisectors of the first side surface and the second side surface at an equal distance from the first surface and the second surface.

5. A vibrating piece comprising:
a driving arm formed of a non-piezoelectric body;
a piezoelectric body provided in the driving arm; and
electrodes fixed to the piezoelectric body, wherein
the electrodes are provided asymmetrically with respect to an equally dividing plane of the driving arm orthogonal to a direction of excited vibration of the driving arm.

6. A gyro sensor comprising the vibrating piece according to claim 1.

7. A gyro sensor comprising the vibrating piece according to claim 4.

8. A gyro sensor comprising the vibrating piece according to claim 5.

9. An electronic apparatus comprising the vibrating piece according to claim 1.

10. An electronic apparatus comprising the vibrating piece according to claim 4.

11. An electronic apparatus comprising the vibrating piece according to claim 5.

12. A mobile body comprising the vibrating piece according to claim 1.

13. A mobile body comprising the vibrating piece according to claim 4.

14. A mobile body comprising the vibrating piece according to claim 5.

15. A manufacturing method for a vibrating piece comprising:
arranging a vibrating piece including a driving arm at least partially formed by a piezoelectric body and electrodes provided in the driving arm; and
partially deleting the electrodes and forming notch portions in the electrodes.

16. A manufacturing method for a vibrating piece comprising:
arranging a vibrating piece including a driving arm formed by a non-piezoelectric body, a piezoelectric body provided in the driving arm, and electrodes provided in the piezoelectric body; and
partially deleting the electrodes and forming notch portions in the electrodes.
